(19) United States
(12) Patent Application Publication
(10) Pub. No.: US 2017/0040009 A1
(43) Pub. Date: Feb. 9, 2017

(54) MIDI Controller Utilizing Replaceable Controls

(71) Applicant: Daniel Paul Daily, Taos, NM (US)

(72) Inventor: Daniel Paul Daily, Taos, NM (US)

(21) Appl. No.: 14/818,898

(22) Filed: Aug. 5, 2015

(51) Int. Cl. G10H 1/00

(52) U.S. Cl. CPC G10H 1/0066; G10H 2230/175; G10H 2230/181; G10H 2230/191; G10H 2230/211; G10H 2230/281; G10H 2220/005

(57) ABSTRACT

An electronic microcontroller-based device outputting electronic signals in one or more electronic communication protocols such as serial MIDI and MIDI-over-USB that features inputs for the connection of user selectable control devices which can control all aspects of the outputted electronic signals is disclosed. External inputs may be switches, analog or digital controls, or a combination, outputting one or more electronic values, digital control messages or both. The apparatus may be used to control: musical sounds in the manner of a limited or fully chromatic musical instrument, musical software, or any electronic device or software that permits control by externally based electronic signals, messages or both.

### BACKGROUND OF THE INVENTION

1. Field of the Invention

The present invention relates to an electronic control device which, depending on the state of the device's internal and user chosen externally connected controls, outputs one or a series of discreet messages in the serial MIDI communications protocol, or the MIDI-USB communications protocol or another computer communications protocol or a combination of computer communications protocols. This device can be used to control sound producing electronic devices or other music making electronic devices but can also be used to control any device capable of electronic control.

2. Description of the Prior Art

Prior Art MIDI controllers are devices which are primarily and nearly exclusively operated by a given set of controls which are fixed and incorporated into the electronic apparatus. Where external controls can be attached to the electronic apparatus, either physically or wirelessly, they perform an auxiliary function, not a primary function essential to the operation of the device such as the determination of the basic note message. Users are forced to adapt to the set of controls provided. What is needed is a device which, by the attachment of controls chosen by the user and placed according to the choice of the user, consequently adapts to the conditions and preferences of the user.

U.S. Pat. No. 6,002,080 describes a MIDI controller which imitates a modern woodwind instrument by providing a series of sensors which determine the output of the device.

U.S. Pat. No. 6,002,080 is deficient because the sensors are not relocatable nor can any be replaced with one chosen (or selected) by the user. The method of choosing the notes cannot be modified by the user.

U.S. Pat. Nos. 7,049,503 and 7,829,780 describe a MIDI controller which comprises a series of electro-mechanical “parts and accessories” which fit onto an existing acoustic saxophone.

U.S. Pat. Nos. 7,049,503 and 7,829,780 are deficient because the sensors are not relocatable nor can any be replaced with one chosen (or selected) by the user. The method of choosing the notes cannot be modified by the user.

### SUMMARY OF THE INVENTION

The present invention is an electronic apparatus, which allows a multiplicity of switches, sensors and other electronic devices to be connected to the apparatus, as well as a multiplicity of devices integrated into the apparatus, used alone or in combination to control the output of the apparatus which are electronic signals interpreted as messages in one or more electronic communication protocols such as Serial MIDI and USB-MIDI. Switches, sensors and other electronic devices can be connected to the apparatus with wires, fiber optic cable or by wireless means. The apparatus can be configured to determine the nature and specifics of the messages that are output, based on the state of the control devices attached to the apparatus and/or integrated into the apparatus.

It is therefore a primary objective of the present invention to provide an electronic apparatus capable of sending messages in one or more electronic communications protocols which adapts to the user by means of a flexible control scheme accomplished by allowing the user to choose which control devices to use as the human interface and how the apparatus will act with regard to the state of those control devices. This allows the device to adapt to the user rather than the user having to adapt to a given or integrated set of controls.

It is another primary objective of the present invention to provide a means for users who for whatever reason cannot operate electronic devices with the pre-determined, established or integrated human interface provided by the maker to operate the apparatus by providing the opportunity and means to use their choice of auxiliary control apparatus which by the above described means, provides a flexible and adaptable control scheme.

It is another primary objective of the present invention to provide a means by which, due to the remotely locatable nature of the chosen control devices, two or more users with different abilities and capacities can conveniently and efficiently operate the present invention together.

It is another objective of the present invention to provide an alternate means, as described above for specifically operating electronic musical devices such as but not limited to, dedicated electronic sound modules and music production devices, and computer software for music production.

It is another objective of the present invention to provide an alternate means, as described above for operating any electronic device or computer software which allows control via the same communication protocol as is output by the present invention such as theater lighting, video manipulation software or other electronically controlled applications.

These and other objectives of the present invention will become apparent to those skilled in this art upon reading the accompanying description, drawings, and claims set forth herein. The headings provided herein are for the convenience of the reader only. No headings should be construed to be limiting upon the content in any way.

### BRIEF DESCRIPTION OF THE DRAWINGS

FIG. 1 is a block diagram of the present invention.

FIG. 2 is a circuit diagram of the Auxiliary Board.

FIG. 3 is a circuit diagram of the LED Display.

FIG. 4 is a circuit diagram of the Jack Interfaces.

FIG. 5 is a circuit diagram of the USB Slave Port.

FIG. 6 is a circuit diagram of the In-Circuit Serial Programming.

FIG. 7 is a circuit diagram of the Micro Controller Unit.

FIG. 8 is a circuit diagram of the USB Interface.

FIG. 9 is a circuit diagram of the Power Supplies.

FIG. 10 is a circuit diagram of the Bootstrap Loader/Selector.

FIG. 11 is a circuit diagram of the Standard Serial MIDI Output.

FIG. 12 is a circuit diagram of the Memory.

### DETAILED DESCRIPTION OF THE INVENTION

### 1. Definitions

The term, “input devices” as used herein shall mean any sort of electronic or electrical apparatus which, when examined or measured by the present invention, results in a quantifiable value.

The term “MIDI controller” as used herein shall mean an electronic apparatus which outputs MIDI messages over a hardware interface such as Serial MIDI or MIDI over USB.

The term “MIDI” as used herein is an acronym for the Musical Instrument Digital Interface, an electronic communications protocol the specification of which has been publicly available for over 35 years.

### 2. Best Mode of the Invention

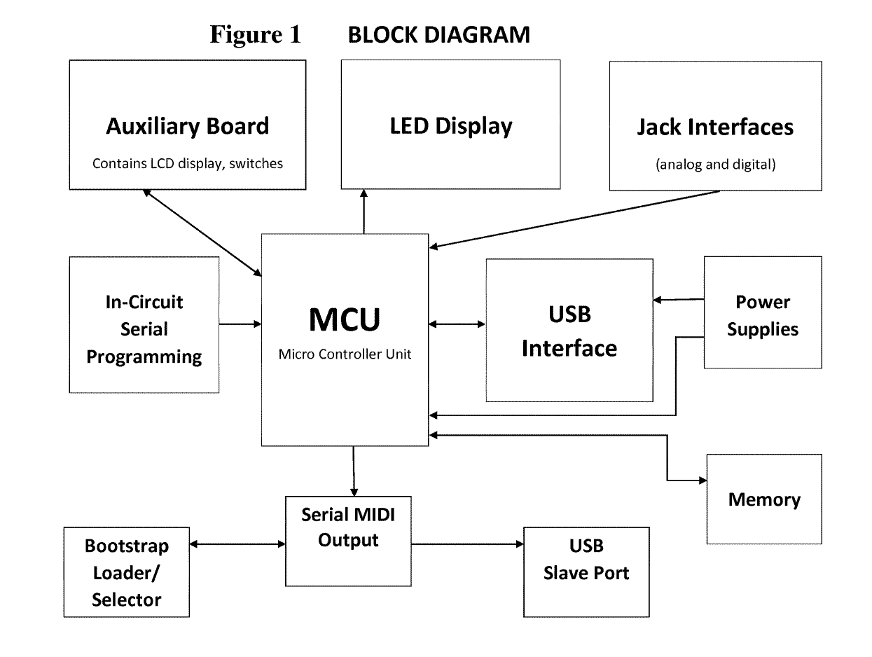

FIG. 1 shows a block diagram of the present invention.

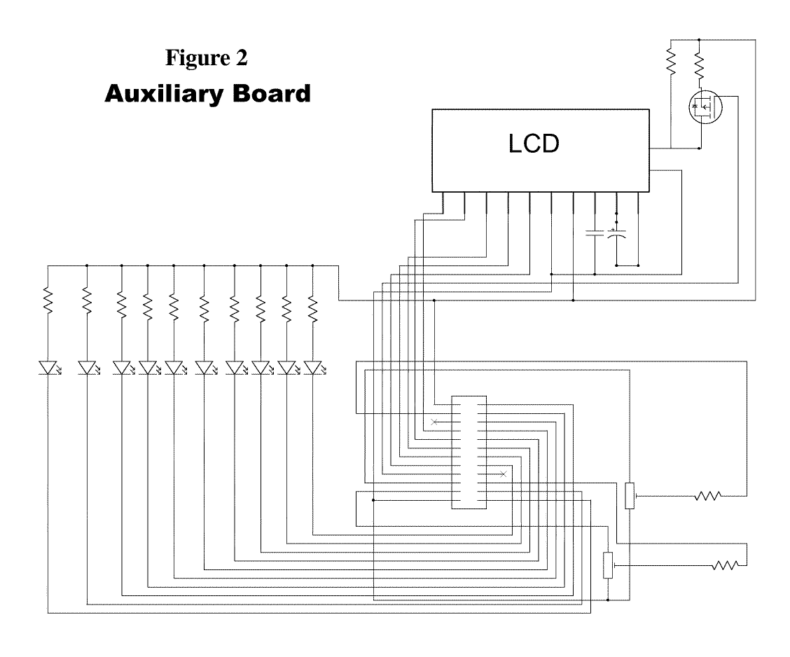

FIG. 2 shows a circuit diagram of the Auxiliary Board using a Liquid Crystal Display (LCD) display such as the Newhaven Display International NHD-C0216CZ-NSW-BBW-3V3.

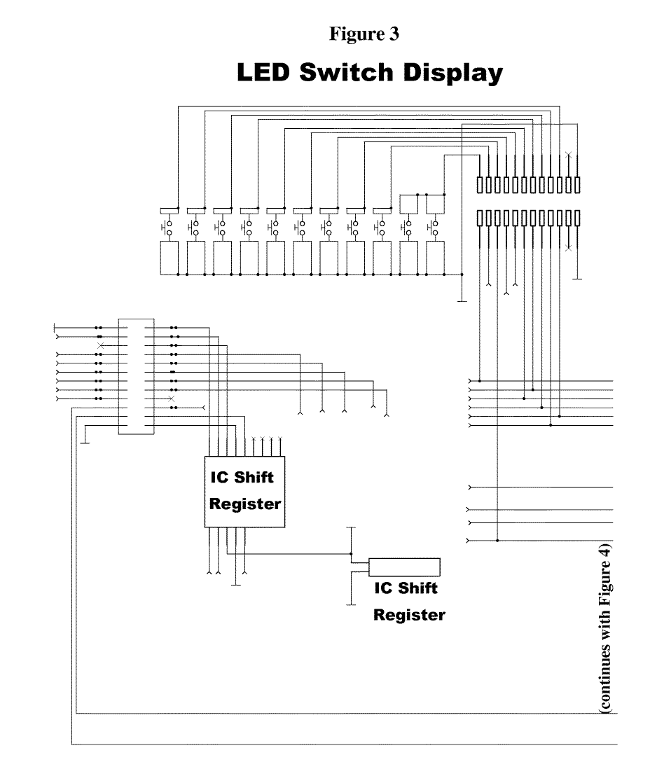

FIG. 3 shows the circuit diagram of the LED Switch Display using an IC shift register such as the ON Semiconductor MC74HC595ADR2G.

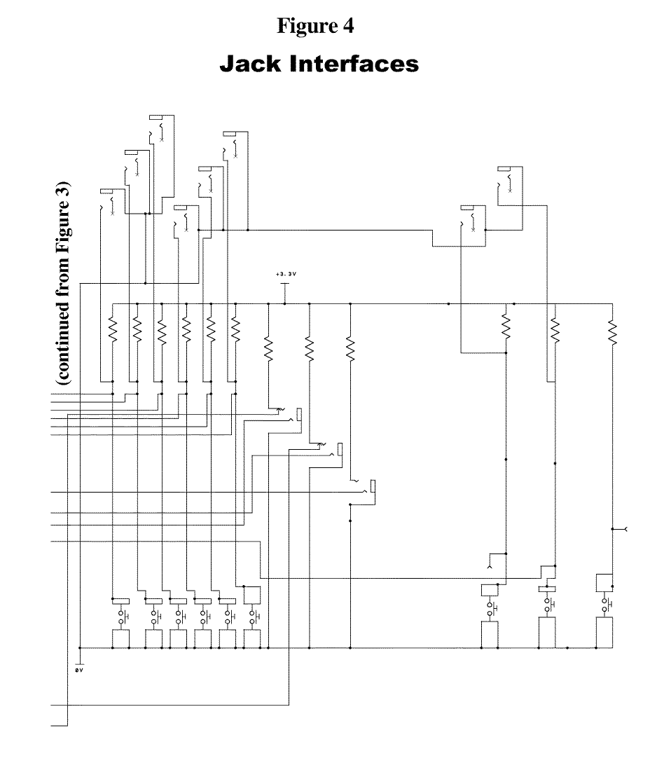

FIG. 4 shows the circuit diagram of the wired digital and analog Jack Interfaces.

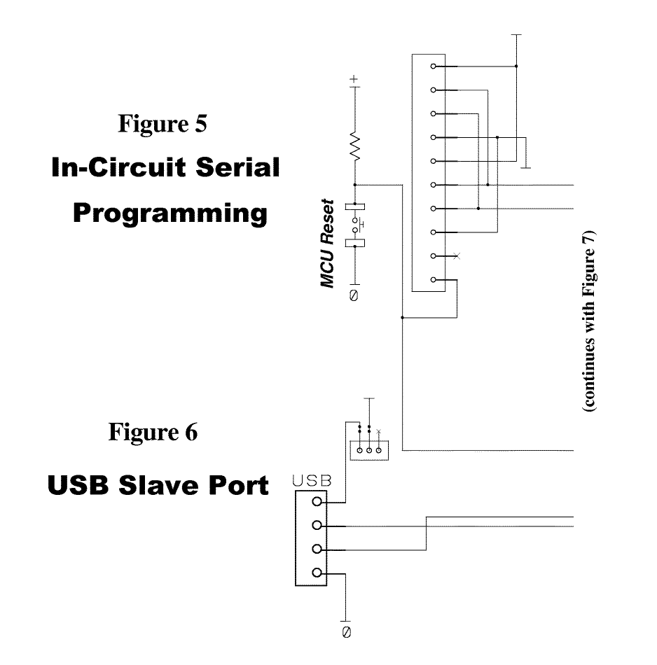

FIG. 5 shows the circuit diagram of the In-Circuit Serial Programming.

FIG. 6 shows the circuit diagram of the USB Slave Port.

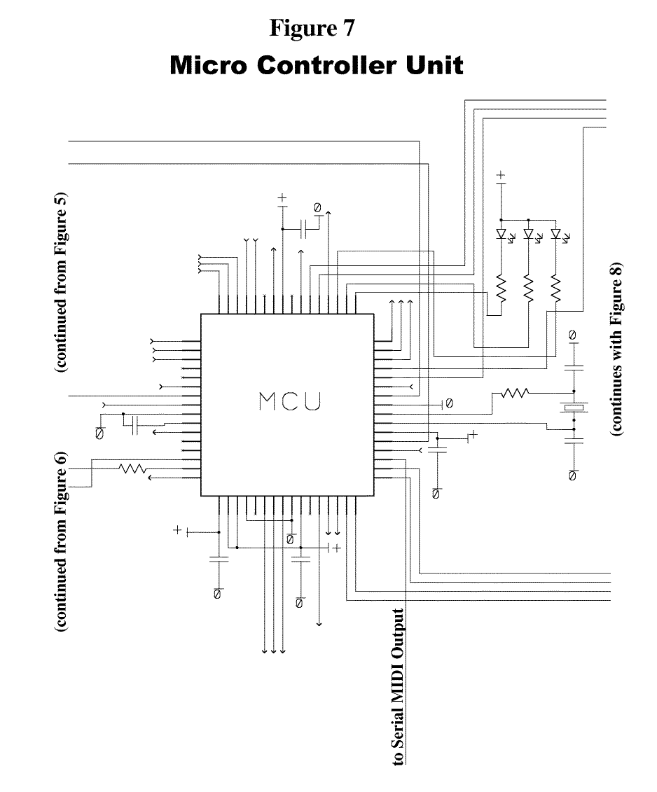

FIG. 7 shows the circuit diagram of the Micro Controller Unit utilizing a Programmable Interface Controller such as the Microchip Technology PIC18F67J50.

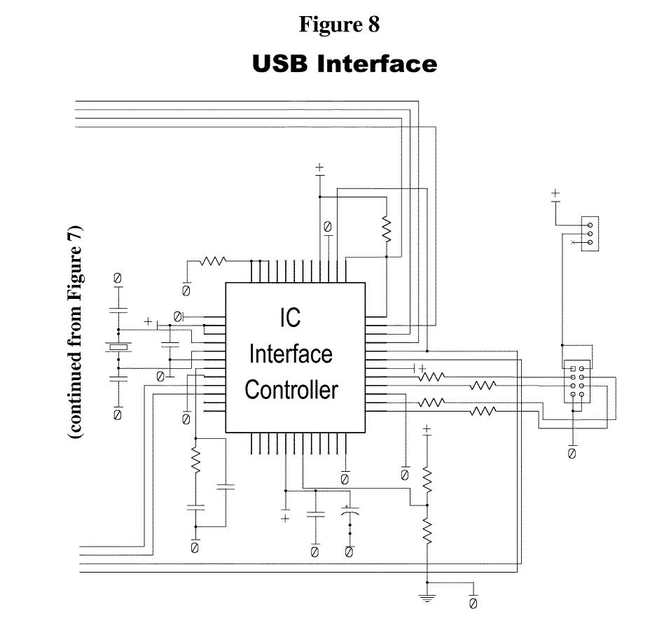

FIG. 8 shows the circuit diagram of the USB Interface using an IC Interface Controller such as the Future Technology Devices International VNC1L-1A.

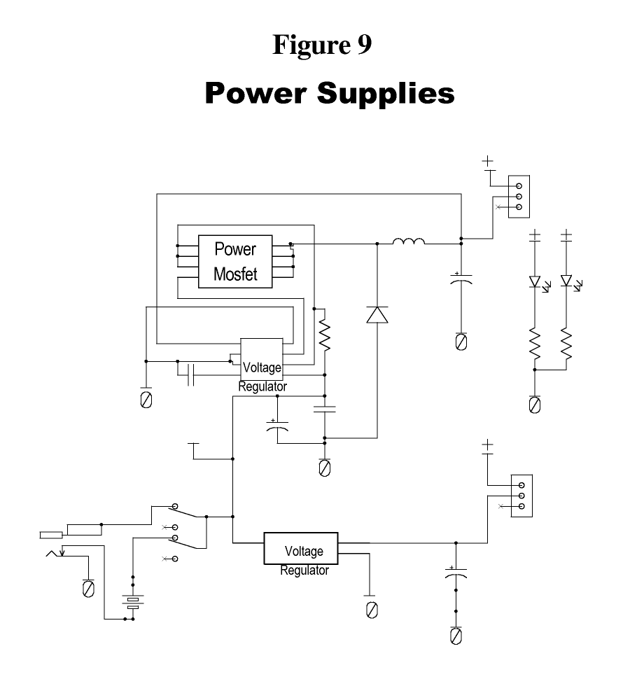

FIG. 9 shows the circuit diagram of the Power Supplies utilizing a Power MOSFET such as the International Rectifier IRF7416TRPBF and voltage regulators such as the Maxim Integrated MAX1626ESA+T and the STMicroelectronics L7805CDT-TR.

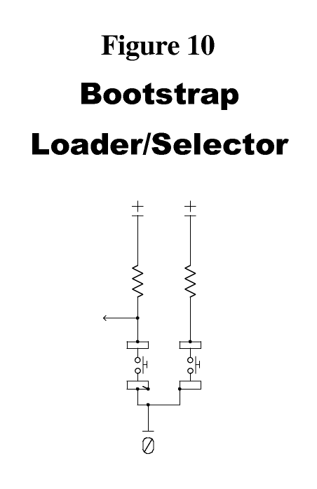

FIG. 10 shows the circuit diagram of the Bootstrap Loader/Selector.

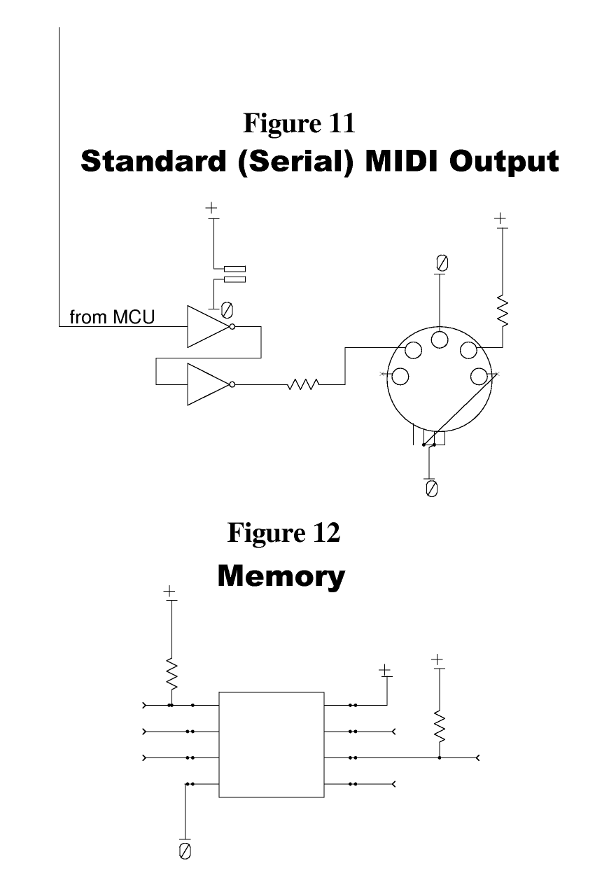

FIG. 11 shows the circuit diagram of the Standard Serial MIDI Output using a IC Dual Inverter such as the NXP Semiconductors 74LVC2G04GW,125.

FIG. 12 shows the circuit diagram of the Memory using an integrated circuit flash memory chip such as the Micron Technology Inc. M25P16-VMN6P.

This embodiment implements the computer communication protocol of MIDI through the hardware interface of Serial MIDI and MIDI over USB (USB-MIDI) but is not limited to this communication protocol or hardware interfaces.

### 3. How to Make the Invention

The current embodiment of the present invention has the following major components:

A. A power supply section to provide 5V DC and 3.3V DC to the circuit.

B. A microcontroller unit (MCU) The central element of the MCU can be a commercially available Programmable Interface Controller. (PIC) The PIC is programmed in the C programming language.

C. A section which handles input from standard USB devices. This is accomplished with a commercially available dedicated Integrated Circuit (IC) specifically designed for this purpose.

D. A section containing the circuitry for standard MIDI output, the specification of which has been publicly available for over 35 years.

E. A section containing the circuitry for MIDI through USB commonly known as USB-MIDI, the specification of which has been publicly available for over 15 years.

F. A section containing the LCD display and LED lights, used for displaying the state of the instrument to users and assisting users in configuring the unit.

G. Optional input devices which are attached to the device.

H. An interface section containing the requisite hardware to connect external input devices to the current embodiment of the present invention.

I. On-board flash memory to allow various configurations of the current embodiment of the present invention, that is, the output of the device depending on the state of the on-board and outboard control devices of the apparatus and the manner in which information is displayed by the LCD and LEDs to be retained when the unit is powered down.

Analog input connections are made to various leads of the PIC, USB input connections are made to the various leads of the IC handling USB input devices.

The microcontrollers need to be programmed with appropriate software instructions.

### 4. How to Use the Invention

The current embodiment of the present invention outputs electronic signals in the standard serial MIDI and USB-MIDI communication protocols simultaneously. The present invention is connected via standard MIDI cable or standard USB cable to a personal computer, tablet, smartphone, dedicated sound producing module or other sound producing device. The present invention is powered up and depending on the state of the input devices both on board and external, when the switch is activated to start sending messages, the receiving device will respond appropriately, depending on the purpose of the dedicated sound producing module or the purpose of the software actively running on the device to which it is connected.

One primary use of the present embodiment of this invention is to control the pitch, volume and other parameters of the selected sound in the dedicated sound producing module to which this invention is connected or the selected sound available in the software running on the device to which this invention is connected. This means that the present invention can be used to act as a musical instrument.

Since electronic signals can be interpreted in any manner desired by a receiving device, the present invention can be made to control any electronic device for whatever purpose the controlled device is designed. All that is required is that a correspondence be established between the electronic messages output by the present invention and the specific functions of the device to be controlled. This means that the present invention can be utilized to control devices which are not related to music or music performance.

Since a variety of input devices can be connected to the present invention and placed wherever convenient for the user or users, it can be configured to adapt to the physical capabilities of the user or users.

### 5. Examples of the Invention

Thus it will be appreciated by those skilled in the art that the present invention is not restricted to the particular embodiments described with reference to the drawings, and that the variations may be made therein without departing from the scope of the present invention as defined in the appended claims and equivalents thereof.

1. An electronic apparatus comprising: electronic components that accepts a plurality of remotely locatable switches that connect physically or wirelessly to the device; the combination of which produces an electronic signal output initiated by the user.

2. An electronic apparatus according to claim 1 wherein the electronic components accept one or a plurality of electronic devices that produce a plurality of electronic values that connect physically or wirelessly to the device, the combination of which produces a single electronic signal output or a plurality of electronic signal outputs.

3. An electronic apparatus according to claim 1 wherein depending on the state of the connected (input) devices, outputs an electronic signal in any computer communications protocol such as the MIDI computer communications protocol.

4. An electronic apparatus according to claim 1 wherein depending on the state of the connected (input) devices, outputs an electronic signal over any computer hardware interface selected from the group of Serial MIDI, USB, Ethernet, or Thunderbolt.

5. An electronic apparatus according to claim 1 wherein depending on the state of the connected (input) devices, outputs a useful electronic signal such as a control voltage.

6. An electronic apparatus according to claim 1 wherein depending on the state of the connected input devices, outputs a multiplicity of electronic signals in any computer communications protocol such as the MIDI computer communications protocol.

7. An electronic apparatus according to claim 1 wherein depending on the state of the connected input devices, outputs a multiplicity of electronic signals over one or more computer hardware interfaces selected from the group of Serial MIDI, USB, Ethernet, or Thunderbolt.

8. An electronic apparatus according to claim 1 wherein it includes in its physical composition devices that produce either two electronic values or devices that produce a plurality of values, or both, that are connected physically or wirelessly to the device, that output either a single electronic signal or multiplicity of electronic signals in any computer communications protocol such as the MIDI computer communications protocol.

9. An electronic apparatus according to claim 1 wherein it includes in its physical composition devices that produce either two electronic values and/or devices that produce a plurality of values that connect physically or wirelessly to the device, output either a single electronic signal or multiplicity of electronic signals over one or more computer hardware interfaces selected from the group of Serial MIDI, USB, Ethernet, or Thunderbolt.

10. An electronic apparatus according to claim 1 wherein depending on the state of both the connected devices that produce two electronic values and/or devices that produce a plurality of values and the devices that produce two electronic values and/or devices that produce a plurality of values which are built into the device, output either a single electronic signal or multiplicity of electronic signals in any computer communications protocol such as the MIDI computer communications protocol.

11. An electronic apparatus according to claim 1 wherein depending on the state of both the connected devices that produce two electronic values and devices that produce a plurality of values, and the devices that produce two electronic values and devices that produce a plurality of values which are built into the device output either a single electronic signal or multiplicity of electronic signals over one or more computer hardware interfaces selected from the group of Serial MIDI, USB, Ethernet, or Thunderbolt.

12. An electronic apparatus according to claim 1 wherein depending on the state of both the connected devices and devices that are built into the device output either a single electronic signal or multiplicity of electronic signals in two or more computer communication protocols.

13. An electronic apparatus according to claim 1 wherein depending on the state of both the connected and the devices that are built into the device output either a single electronic signal or multiplicity of electronic signals over two or more computer hardware interfaces.

14. An electronic apparatus according to claim 1 wherein the message output scheme mimics the operation of the traditional trumpet wherein the electronic value of one analog input device determines the basic electronic message output in accordance with to the overtone series, or subset thereof, and one digital or analog switch changes the electronic message output by a specified value.

15. An electronic apparatus according to claim 1 wherein the message output scheme mimics the operation of the traditional trumpet wherein the electronic value of one analog input device determines the basic electronic message output in accordance with the overtone series, or subset thereof, and two or more digital or analog switches change the electronic message output by a specified value.

16. An electronic apparatus according to claim 1 wherein the message output scheme mimics the operation of the traditional trumpet wherein the electronic value of one analog input device determines the basic electronic message output in accordance with the overtone series, or subset thereof, and two or more digital or analog switches used in combination change the electronic message output by a specified value.

17. An electronic apparatus according to claim 1 wherein the message output scheme mimics the operation of the traditional trombone wherein the electronic value of one analog input device determines the basic electronic message output in accordance with the overtone series, or subset thereof, and another analog input device modifies the electronic message output by a specified value depending on its electronic output value.

18. An electronic apparatus according to claim 1 wherein the message output scheme mimics the operation of the traditional trombone with an F attachment wherein the electronic value of one analog input device determines the basic electronic message output in accordance with the overtone series, or subset thereof, and another analog input device modifies the electronic message output by a given value depending on its electronic output value and where one or more digital or analog switches change the electronic message output by a specified value.

19. An electronic apparatus according to claim 1 wherein the message output scheme mimics the operation of the traditional double French Horn wherein one analog input device determines the basic electronic message output in accordance with to the overtone series, or subset thereof, of one or the other of the two “sides” of the traditional double French Horn and one digital or analog switch changes the electronic message output by a given value.

20. An electronic apparatus according to claim 1 wherein the message output scheme mimics the operation of the traditional double French Horn wherein one analog input device determines the basic electronic message output in accordance with to the overtone series, or subset thereof, of one or the other of the two “sides” of the traditional double French Horn and two or more digital or analog switches used in combination change the electronic message output by a specified value.

21. An electronic apparatus according to claim 1 wherein the message output scheme mimics the operation of the traditional triple French Horn wherein one analog input device determines the basic electronic message output in accordance with to the overtone series, or subset thereof, of one of the three “sides” of the traditional triple French Horn and one digital or analog switch changes the electronic message output by a specified value.

22. An electronic apparatus according to claim 1 wherein the message output scheme mimics the operation of the traditional triple French Horn wherein one analog input device determines the basic electronic message output in accordance with to the overtone series, or subset thereof, of one of the three “sides” of the traditional triple French Horn and two or more digital or analog switches used in combination change the electronic message output by a specified value.

23. An electronic apparatus according to claim 1 wherein the message output scheme mimics the operation of the traditional non-chromatic harmonica wherein one or more ranges of the analog device determine the basic electronic message corresponding to the notes available on the non-chromatic harmonica and one digital or analog switch changes the electronic message output by a specified value.

24. An electronic apparatus according to claim 1 wherein the message output scheme mimics the operation of the traditional non-chromatic harmonica wherein one or more ranges of the analog device determine the basic electronic message corresponding to the notes available on the non-chromatic harmonica and two or more digital or analog switches used in combination change the electronic message output by a specified value.

25. An electronic apparatus according to claim 1 wherein the message output scheme mimics the operation of the traditional drum set whereby the state of the device outputs one or more electronic messages which may correspond to either a single percussion sound (one electronic message) or a combination of percussion sounds. (multiple electronic messages)

26. An electronic apparatus according to claim 1 wherein the message output scheme allows the manipulation of electronically based images in such tasks selected from the group of record, choose image, zoom, resize, resample, crop, print, manipulate color, brightness, contrast, selection of elements and any other tasks the external image device or image software allows to be controlled by electronic messages.

27. An electronic apparatus according to claim 1 wherein the message output scheme allows the manipulation of video images in such tasks such as, but not limited to, recording, playback, selection, content manipulation and any other tasks the external video device or video software allows to be controlled by electronic messages.

28. An electronic apparatus according to claim 1 wherein the message output scheme allows the control or manipulation of any tasks the external device or computer software allows to be controlled by electronic messages or signals.

29. An electronic apparatus according to claim 1 wherein other externally generated MIDI input or messages in another communication protocol or useful electronic signal are manipulated according to the intention of the user and the state of the apparatus.

30. A Method by which the range of an input device producing a continuously variable output signal or value is divided into two or more ranges, each range producing a single output, whether a useful electronic signal, a message in any computer communications protocol or hardware interface, or combination of these.
